(19) United States
(12) Patent Application Publication
(10) Pub. No.: US 2009/0187648 A1
(43) Pub. Date: Jul. 23, 2009

(54) Security Adapter Discovery for Extensible Management Console

(75) Inventors: Krishna Sunkammurali, Sammamish, WA (US); Israel Hilerio, Kenmore, WA (US); Lingan Satkunanathan, Kirkland, WA (US); Bruce Johnson, Woodinville, WA (US); Aaron Colling, Seattle, WA (US); Christer Lundin, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/016,196

(22) Filed: Jan. 17, 2008

(51) Int. Cl. G06F 15/173

(52) U.S. Cl. 709/223

(57) ABSTRACT

An extensible management console may use a discovery mechanism to detect and identify security services across a network. After identification, the console may download and install an adapter so that the security service may be monitored and controlled using the extensible management console. A catalog of security services may be obtained from a catalog server and used to scan various devices, registries, file systems, and active services to detect and identify security services that may be added to the extensible management console.

### BACKGROUND

In many business computing systems, multiple servers may be used to operate many different services and applications across a network. For each server device, many more client devices may be attached to the network. Each device on the network, client and server alike, may have one or more security related applications or services. In some cases, server devices may have specialized security applications for firewall applications, email and messaging scanning, content filtering, or other functions.

As an enterprise grows, the number and complexity of the security applications across the enterprise can be difficult to manage. Each application on each device may have different settings which may affect the security application's effectiveness. Monitoring and controlling security applications across the various server devices on the network may be an important administrative function to vigilantly ensure that a network is properly protected.

### SUMMARY

An extensible management console may use a discovery mechanism to detect and identify security services across a network. After identification, the console may download and install an adapter so that the security service may be monitored and controlled using the extensible management console. A catalog of security services may be obtained from a catalog server and used to scan various devices, registries, file systems, and active services to detect and identify security services that may be added to the extensible management console.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing an environment with an extensible management console.

FIG. 2 is a diagram illustration of an embodiment showing a management console.

FIG. 3 is a flowchart illustration of an embodiment showing a method for using security adapters.

### DETAILED DESCRIPTION

An extensible management console may have a discovery mechanism to detect new security services operating within the environment that may be controlled by the console. When a new security service is detected and identified, an adapter may be received from an adapter server and installed for use in the console.

The extensible management console may use a catalog of descriptors that is received from a catalog server for detecting new security services. The descriptors may be items such as registry entries, specific configuration files, groups or arrangements of files within a file system, the presence of certain services or agents operable on a device, or other identifiers. A crawler or other discovery mechanism may search a local system as well as other devices connected to a network to discover new or updated security services that may be operating.

When a new service is installed or an existing service is updated, an installation mechanism may contact an adapter server and receive an adapter or updated configuration parameters. The installation mechanism may install the new adapter or update the configuration parameters so that the extensible management console may be able to interface with the security service.

The extensible management console may be used to manage various services, applications, and devices across a network. In many cases, the extensible management console may provide a consolidated user interface for many different services, including devices, services, and applications provided by different vendors and which provide different functions. The extensible management interface may use a set of adapters or plugins that may include specific communications tools, user interface, and logic that may be used to receive and display status information as well as send commands and queries to the monitored devices, services, and applications. In many cases, each device, service or application may have a standalone interface as well as a plugin or adapter that enables monitoring and control through the extensible management console.

The monitoring, control, and administration of security services are functions that may have wide ranging implications for a company or enterprise. A security breach may make the enterprise vulnerable to infiltration of malicious software which may cripple a company's performance and may cause extensive damage. In some cases, security services may be used to screen incoming and outgoing messages for content and may be used to ensure that company trade secrets are not intentionally or unintentionally dispersed outside the company. Because of the dynamic nature of potential security issues and the potential risk of catastrophic damage, security services operating within an enterprise may be detected and added to an extensible management console for ease of administration and monitoring.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

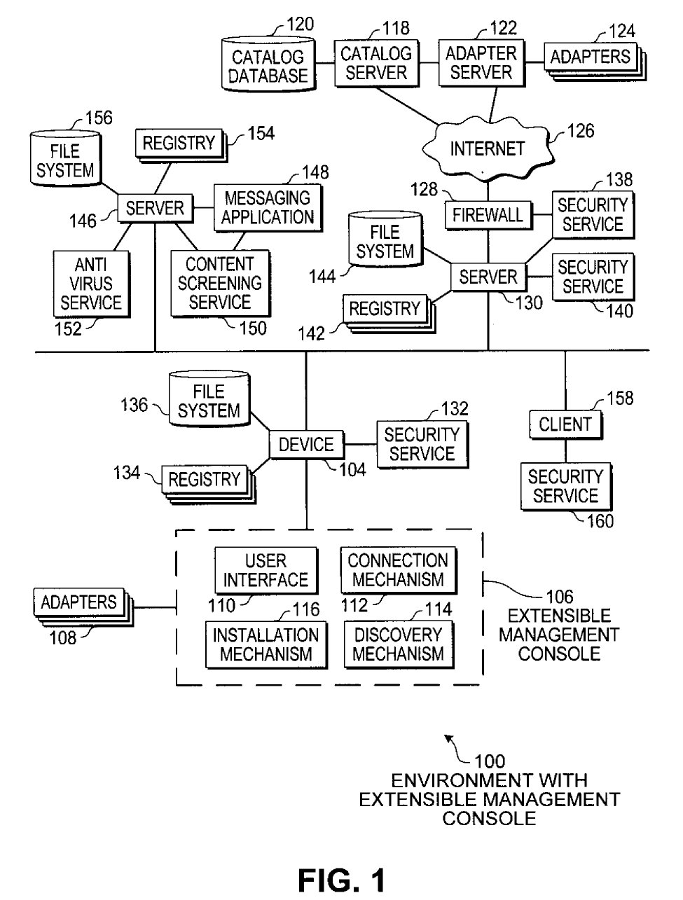

FIG. 1 is a diagram of an embodiment 100 showing an environment with an extensible management console. Embodiment 100 is a simplified example used to highlight various characteristics and features of an extensible management console.

The diagram of FIG. 1 illustrates functional components of a system and may not correspond directly with a hardware or software component of a system. In some cases, a component may be a hardware component, a software component, or a combination of hardware and software. Hardware components may include general purpose components adaptable to perform many different tasks or specially designed components that may be optimized to perform a very specific function. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the various functions described.

The network 102 may be used to connect various devices in a local area or wide area network. The device 104 is connected to the network 102 and operates an extensible management console 106. The extensible management console 106 may be used to manage several different devices, services, and applications operating across the network. In a typical use scenario, an extensible management console may be used to administer a computer network for a company. Such a network may have several servers and many client devices, as well as network devices such as switches, hubs, routers, access points, firewalls, and gateways.

The extensible management console 106 may be used to administer various items from a single user interface. A set of adapters 108 may be used for some or all of the interfaces to each monitored item. For example, an adapter 108 may include scripts, protocols, or commands that may be used by the extensible management console 106 to communicate with a monitored item. In some cases, the extensible management console 106 may communicate with a monitored device, service, or application directly, while in other cases an agent or monitoring daemon may be used as an intermediary application between the extensible management console 106 and the monitored device, service, or application.

The extensible management console 106 may include a user interface 110. The user interface 110 may be presented to a user to display status and performance information from a monitored item as well as enable a user to cause various commands or actions to be executed by the monitored item. In many cases, an adapter 108 may include a user interface definition that may include various text, graphics, images, and other display items. Some adapters may include definitions of how status items may be displayed, such as using graphical mechanisms such as multicolored indicators, charts, instrument displays, or other items.

Many adapters may include a layout definition of a user interface. For example, a user interface portion of an adapter may include hyper text markup language (HTML) or other definition of various layout and arrangement characteristics of various user interface components.

Adapters may also include various input mechanisms by which a user may select, click, type, or otherwise provide input. The input may be used by the extensible management console to create commands that may be transmitted to the monitored device, service, or application. The logic or algorithms that may interpret the user input and create the commands may be defined within an adapter for the service.

Each adapter may be specially designed for device, service, or application that is monitored. The adapter may include any specific communications protocols, sequences, algorithms, analysis, or other definitions that may enable the extensible management console 106 to connect with and administer the monitored item. In some cases, the adapter may include executable binary code, scripts, configuration information, or other data in other forms.

The extensible management console 106 may include a connection mechanism 112, a discovery mechanism 114, and an installation mechanism 116 that may be used to detect the presence of a security service, receive an adapter, and install the adapter so that the security service may be monitored and administered by the extensible management console 106.

The connection mechanism 112 may be adapted to establish a communication with a catalog server 118 and receive a catalog of supported security services from the catalog database 120. The catalog of supported security services may include descriptors of supported security services that may be used by the discovery mechanism 114 to locate security services.

The descriptors for security services may include any item that may indicate that a security service is available. Examples of descriptors may include registry settings known to be configured by certain security services, certain files within a file system, the arrangement or file structure within a file system that may be used by a security service, the presence of a security service or agent operating on a device, or some other indicator. In some instances, the descriptors may be used in a recursive or hierarchical manner to detect a first item, such as a registry setting, then search for a specific executable file or examine operating services for a specific type of service.

In many cases, security services may be designed to operate in a mode where the service is difficult to detect. For example, a security monitoring service may operate as a background process with a confusing name so that a user of a client device is unaware that the security monitoring service may be operational. In such cases, the security services may be difficult to detect. Once the service is detected, an adapter may be used to interface and administer the security service.

The connection mechanism 112 may use various connection techniques to receive a catalog containing security service descriptors. In some embodiments, the extensible management console 106 may subscribe to a periodically published distribution of updated catalogs. In such cases, the various distributions may include an entire catalog or may include just data that is updated or added to the catalog.

In some embodiments, the connection mechanism 112 may be capable of downloading a catalog from the catalog server 118 using file transfer protocol (FTP) or some other mechanism where the connection mechanism 112 may pull the catalog from the catalog server 118. In other embodiments, the catalog server 118 may be arranged to push a catalog or updates to a catalog to the connection mechanism 112.

The connection mechanism 112 may be configured to operate on a periodic basis, such as once a day, once a week, or once a month. In some embodiments, the connection mechanism 112 may be operated asynchronously such as when an updated catalog is available, when an update is received, or when an administrator requests.

The discovery mechanism 114 may use one or more different techniques to discover a security service. In some cases, a discovery mechanism 114 may examine a file system such as the local file system 136 attached to device 104. Some security devices may be installed by placing certain files in specific directories. Other security devices may have a specific directory structure or arrangement that may be used as an indicator that a security service is installed. In other cases, the discovery mechanism may analyze a local registry 134 for entries that may have been set by security service 132. In still other cases, a list of installed or executing processes may be scanned for the presence of a security service 132.

Other embodiments may examine messaging or other network traffic to determine if a security service is operational somewhere within the network. In such embodiments, a discovery mechanism 114 may monitor network traffic to analyze the contents of messages along the network and determine if a security service is communicating along the network or if a security service is analyzing and tagging messages.

The discovery mechanism 114 may crawl the network 102 to detect and identify various security services. For example, the discovery mechanism 114 may detect server 130 which is connected to a firewall 128 and may serve as a gateway to the internet 126. The server 130 may have a security service 138 that may be controlled by the server 130 and act in conjunction with the firewall 128.

The security service 138 may provide various functions such as network address transfer (NAT), content filtering for web access and email, virtual private network (VPN) connections, and logging messages and activities. The security service 138 may also enable or disable various ports on the connection, which may permit or deny various types of connections through the firewall 128. Other functions provided by the security service 138 may include monitoring against network attacks or other functions.

The security service 138 is an example of a service that may be closely monitored by network administrators. Changes or updates to the security service 138 may have potentially severe impact to the security of the network 102 and to the productivity of a business or enterprise that relies on an internet connection for daily business activities.

The server 130 may have other security services 140 that may have other functions. For example, security service 140 may perform generalized monitoring such as antivirus scanning of the file system 144, script scanning or blocking, web browser content screening, instant messaging scanning or filtering, or other messaging or content scanning and filtering.

In some cases, the security service 140 may be an easily discoverable service, while in other cases, the security service 140 may be a clandestine service which may be intentionally hidden from a user. A clandestine service may monitor activities on a device and report certain activities to an administrator or to a logging function. Such services may have cryptic or deceptive filenames and may behave like worms, Trojan horses, or other malicious software in the sense that they are difficult to detect but may perform various monitoring activities for the benefit of a company or enterprise.

In many cases, a discovery mechanism 114 may analyze the registry settings 142 of the server 130 to determine if a security service has entered a setting. In some embodiments, two or more registries may be present on a system. For example, a system registry may be used for system wide applications or services while separate user registries may be used for services or applications that operate under various user accounts.

The discovery mechanism 114 may crawl the network to detect the server 146, which in the embodiment shown has a messaging application. The messaging application may be, for example, a service that manages and stores email for various users across the network. Such a service may receive email, route email to various user's mailboxes, and provide an application interface to the mailboxes. In many embodiments, a content screening service 150 may also be provided. The content screening service 150 may be a specialized security service that screens incoming and outgoing emails and messages for viruses or other malware as well as screening for inappropriate content. Such content screening may include screening for inappropriate content such as pornography or for information that may be regarded as sensitive or trade secret information.

The server 146 may have an antivirus service 152 that may provide routine scanning of the file system 156 on a periodic basis as well as when files may be added to the file system 156. In many cases, the discovery mechanism 114 may examine the registries 154 for signs of a security service.

The discovery mechanism 114 may detect the client device 158 connected to the network 102 and any security services 160 that may be operational on the client device. The client device 158 may be any type of device, such as a client computer, a server computer, a network management device such as a router or switch, a handheld computing device, network appliance, or any other type of network connected device. In some embodiments, the client 158 may be connected to the network 102 through a wireless connection. The security service 160 may be any type of security related service that may be operate on the client 158. Such services may include anti-virus, anti-malware, content filters, firewalls, or any other type of security service.

Within the embodiment 100, various examples of security services are illustrated but are not intended to be a comprehensive list of the security services that may be detected and monitored using the extensible management console 106. Other embodiments may use different security services and such services may be provided on various types of systems, servers, clients, network devices, or other devices.

The installation mechanism 116 may be used to connect to an adapter server 122 and receive an adapter 124. The installation mechanism 116 may receive a list of security services that were identified by the discovery mechanism 114. In many cases, an administrator or use of the extensible management console 106 may be given the option to download and install an adapter for the discovered security services.

The installation mechanism 116 may connect to and receive an adapter 124 using any communications mechanism. In some cases, the installation mechanism may be provided with a filename or location of an adapter from the catalog information provided from the catalog database 120. Such a location may enable the installation mechanism 116 to request a specific adapter and receive the adapter by a messaging system such as email. In another embodiment, the location information may be used by the installation mechanism 116 to connect to the adapter server 122 and download a specific adapter from a location within a directory structure using File Transfer Protocol (FTP).

In some cases, the installation mechanism 116 may receive specific identification information about a security service and query the adapter server 122 to determine if an appropriate adapter exists.

Some embodiments may enable an installation mechanism 116 to receive and install an adapter and may further enable the installation mechanism 116 to receive configuration information for an adapter. In some cases, a general or multipurpose adapter may be installed and a set of configuration data or settings may be subsequently installed to adapt to the specific security service identified. In such a case, the installation mechanism 116 may make multiple queries and receive multiple sets of data from the adapter server 122.

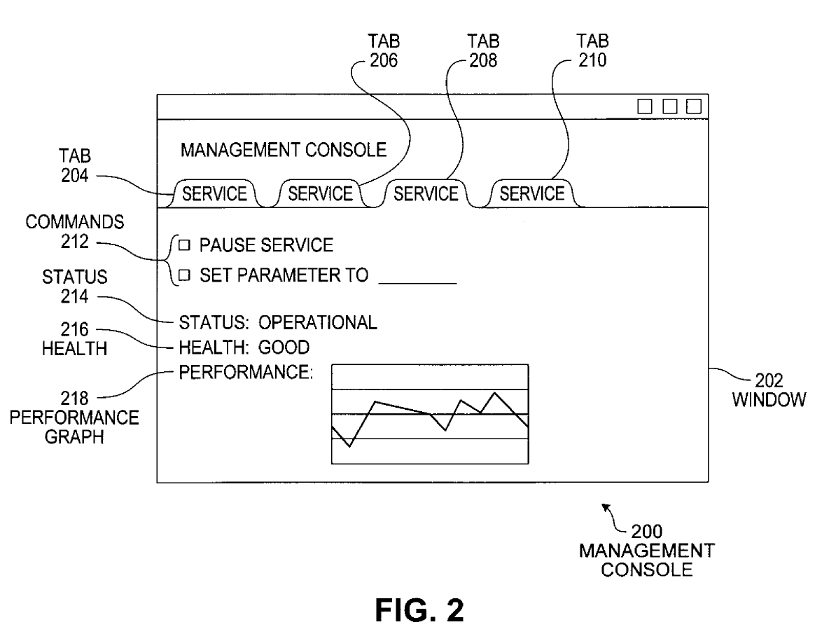

FIG. 2 is a diagram illustration of an embodiment 200 showing a user interface for an extensible management console. Embodiment 200 is merely a simplified example of the various components that may be found within a user interface. Each embodiment may have different layout, look and feel, and specific functionality.

The window 202 may be displayed on a computer user interface and may be used by a user to interact with the various services and devices monitored and controlled by an extensible management console.

The window 202 may include several tabs 204, 206, 208, and 210 that may each refer to a separate plugin that may be installed in an extensible management console. As a plugin is installed, a new tab may be created and added to the management console. When a user selects a tab, such as tab 208 that is currently selected, the user may view specific user interface items that relate to the monitored service.

In many embodiments each tab may be presented with an indicator for the monitored security service. For example, tab 204 has a ‘service’ designation. In a typical embodiment, the term ‘service’ may be replaced with the specific name of a monitored security service, such as ‘Virus Scanner’. Similarly, tab 206 has a ‘service’ designation. In a typical embodiment, the term ‘device’ may be replaced with ‘Mail Content Scanner’ or some other designation.

The user interface for a particular service may include several different items. Commands 212 may be any type of user interface mechanism by which a user may interact with the monitored service or device. In some cases, the commands 212 may be user interface devices such as buttons, drop down lists, text input boxes, or any other user interface device by which a user may select an action. From the user input, a command may be fashioned that may be transmitted to the monitored service or device and executed. In some cases, a user may not recognize that a command may be created and executed by the monitored service or device. Status indicator 214 and health indicator 216 may be summary information that is gathered from various sources.

In many embodiments, a plugin may define status and health indicators for a monitored service using a set of parameters derived from parameters from different services and devices. For example, a status or health indicator for a service or application may include status information from a device on which the service operates or for a service on which the monitored service may depend.

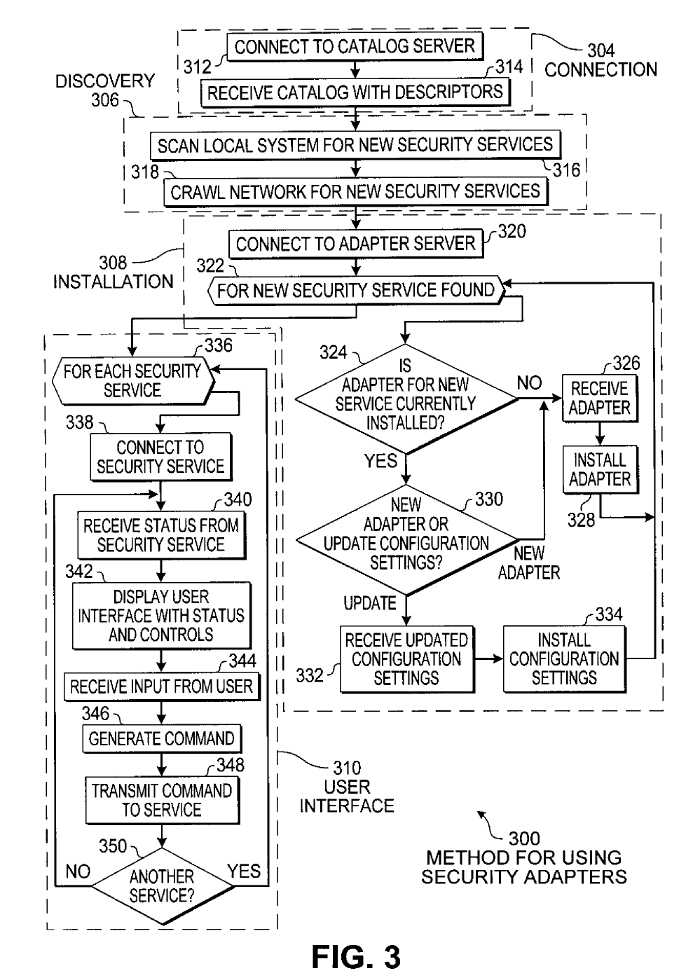

FIG. 3 is a flowchart illustration of an embodiment 300 showing a method for using security adapters. Embodiment 300 is a simplified example of a method for using security adapters, and other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates the steps of connection 304, discovery 306, installation 308, and user interface actions 310 that an extensible management console may use with security adapters.

The connection process 304 may consist of connecting with a catalog server in block 312 and receiving a catalog with descriptors in block 314. The communication with the catalog server may happen in several different methods and sequences.

In one embodiment, the catalog server may have a subscription publication system whereby an extensible management console may subscribe to periodic descriptions. In such an embodiment, a catalog server may send an updated catalog of security services with descriptors on a periodic basis, such as every week or every month. In some cases, the catalog server may send an updated catalog when an update is available.

In some subscription publication embodiments, an extensible management console may subscribe to two or more different feeds, with each feed containing a subset of the all the security services available. For example, a small company may subscribe to one feed for catalogs for various security services that operate on a subset of clients and a second feed for gateway and firewall security services. When the company expands to include an internal email server, the company may subscribe to a catalog feed for security services that address internal email applications.

In some embodiments, the connection process may include a pull type connection whereby the extensible management console connects to a catalog server and downloads a catalog or catalog update. In other embodiments, the connection process may include a push type connection where the catalog server sends a catalog or catalog update to the extensible management console.

The catalog may be transferred as an entire catalog or may be transferred as an incremental update. An incremental update may include changes made to the catalog since the last transmission. In some cases, an incremental update may be transmitted using a subscription publication mechanism, with a mechanism to request or download a full catalog separately.

The catalog may contain various descriptors that may be used for locating a security service. Such descriptors may include file identifiers, such as file names and other metadata such as file size, checksum, or identifier. The file identifier may be used to search a file system to locate a matching file. Once the file is located, it may be analyzed in various ways to verify that the file matches the descriptors. In some cases, the descriptors may include a script or other executable code that may be used to analyze a file to determine authenticity, versions, or settings.

One of the descriptors may be a file or directory configuration. Such a descriptor may include an arrangement of folders or directories, specific names for the directories, certain settings or metadata about the files or directories.

Another descriptor may be a name of a service, agent, or application. Such a name may be used to scan the operating or installed services or executing processes on a device to determine if the service is present. Similarly, a registry setting or name may be a descriptor and used to scan a registry for the presence of a security service.

In some cases, a descriptor may be a characteristic of a message that may be transmitted across a network. The characteristic may be any feature of a message that may indicate that a security service is operational within a network. For example, a service may be detected when the service itself transmits a message across the network. In another example, a security service may process a message in a particular way that may leave a telltale sign, such as a certain bit, a tag, or other signature. By identifying the signature or other anomaly, a service may be detected.

Some embodiments may have a multilayer or multistep protocol for detecting and identifying particular security services. For example, a descriptor may include a particular filename. After discovering the file, the same file or a second file may be analyzed to determine authenticity and other data such as a version number or configuration setting.

The steps of discovery 306 may include scanning a local system for new security devices in block 316 and crawling a network for new security services in block 318. A local system may be the same system that hosts and operates an extensible management console.

Many different devices may exist on a network and each may have some security service operating on the device. Server computers, personal computers, laptop computers, personal digital assistants, mobile devices, handheld scanners, network appliances, network firewalls and gateways, network switching and routing equipment, various input and output devices such as scanners and printers, network enabled instruments and measuring equipment, and any other device on a network may be detected and scanned.

During the scanning process, one or more new security services may be detected and identified. In some cases, the discovery 306 may include identifying a specific version or configuration of a specific security service.

The installation 308 may include connecting to an adapter server 320. In some embodiments, the adapter server and the catalog server may be accessed through the same internet address. In some such cases, the adapter server and catalog server may be the same physical device, while in other cases various servers or clusters of servers may be used.

For each new security service found in block 322, if an adapter for the new service is not already installed in block 324, the adapter is received in block 326 and installed in block 328. The adapter may be received through a downloading mechanism or through some other mechanism.

If the adapter is already installed in block 324, and the new security service uses a new adapter in block 330, the new adapted is received in block 326 and installed in block 328. Such a case may occur when a new security service is found that is an updated version of a service for which an adapter is installed. In such a case, a new adapter may replace an existing adapter.

If the adapter is already installed in block 324, the settings for the adapter may be updated in block 330 by receiving updated configuration settings in block 332 and installing the configuration settings in block 334.

The user interface 310 operation may include communicating with the security service using the adapter, displaying status of the service, and issuing commands to the service.

For each security service in block 336, a connection is made to the service in block 338 and a status is received in block 340 from the security service. The connection and communication may occur differently in various embodiments. In some embodiments, a security service may have an applications programming interface (API) that may enable many different commands and queries to be made with the security service. Some embodiments may have a messaging system interface through which status queries may be made and responses received. In some embodiments, an agent, daemon, or other executable application may be used to facilitate communications between the extensible management console and the security service.

A user interface may be displayed in block 342 that may include some portion of the status information received from the security service. In many embodiments, the user interface portion of an adapter may include algorithms, logic, scripts, or other functional code that may analyze, translate, summarize, organize, or otherwise process the status information into a format that may be displayed within a user interface. In many cases, a user interface may use graphics, colors, text, charts, or other summary or detailed representation of the status data.

The user interface of block 342 may include various input controls. The input controls may be items such as buttons, text input boxes, drop down menu boxes, command line input devices, or any other mechanism by which a user may perform an input operation.

The input may be received in block 344 and a command may be generated in block 346. In many cases, an input may be a button click or some other indicator. Within the adapter used for the user interface, a command may be generated from the user input. In some cases, the command may consist of a script or sequences of commands or operations that may be used to perform a specific function. In some cases, an adapter may include detailed mechanisms for transmitting a command to the security service in block 348.

If additional commands may be processed by the adapter for the current security adapter in block 350, the process may return to block 340. If another security service is requested in block 350, the process may return to block 336.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
an extensible management console user interface;
a connection mechanism adapted to connect to a catalog server and receive a catalog comprising descriptors for a plurality of security services;
a discovery mechanism adapted to search for said plurality of security services using said descriptors and identify a new security service; and
an installation mechanism adapted to connect to an adapter server, receive a security adapter corresponding to said new security service, and install said security adapter in said extensible management console user interface such that said extensible management console user interface may be adapted to interact with said new security service.

2. The system of claim 1, said descriptors comprising at least one of a group composed of:
files;
services;
agents;
registry settings;
messages; and
file configuration.

3. The system of claim 1, said connection mechanism adapted to connect to said catalog server using a subscription publication system.

4. The system of claim 1, said connection mechanism adapted to connect to said catalog server using a pull-type download system.

5. The system of claim 1, said connection mechanism adapted to connect to said catalog server by having said catalog server push an updated catalog to said connection mechanism.

6. The system of claim 1, said discovery mechanism adapted to search on a local device and on at least one network connected device.

7. The system of claim 1, said discovery mechanism further adapted to:
determine that a current adapter is adapted to interface with a first version of a current security service; and
determine that a second version of said current security service is present;
said installation mechanism further adapted to:
configure said current security adapter to operate with said second version.

8. The system of claim 7, said installation mechanism adapted to receive updated settings from said adapter server.

9. The system of claim 7, said installation mechanism adapted to receive and install an updated security adapter for said second version of said current security service.

10. The system of claim 1, said catalog server and said adapter server being reachable through a common network address.

11. A method comprising:
connecting to a catalog server;
receiving a catalog comprising descriptors for a plurality of security services;
scanning using said descriptors to locate a new security service;
connecting to an adapter server;
receiving an adapter for said new security service;
installing said adapter in an extensible management console;
communicating with said new security service using said extensible management console;
sending a command from said extensible management console to said new security service; and
receiving a status from said new security service using said extensible management console.

12. The method of claim 11, said descriptors comprising at least one of a group composed of:
files;
services;
agents;
registry settings;
messages; and
file configuration.

13. The method of claim 11, said scanning comprising:
scanning on a local device; and
scanning on a device accessible through a network.

14. The method of claim 11 further comprising:
determining that a current adapter is adapted to interface with a first version of a current security service;
determining that a second version of said current security service is present;
configuring said current security adapter to operate with said second version.

15. The method of claim 14 further comprising:
receiving updated settings from said adapter server.

16. The method of claim 14 further comprising:
receiving an updated security adapter for said second version of said security service.

17. A computer readable medium comprising computer executable instructions adapted to perform the method of claim 11.

18. An extensible management console comprising:
a connection mechanism adapted to connect to a catalog server and receive a catalog comprising descriptors for a plurality of security services;
a discovery mechanism adapted to search for said plurality of security services using said descriptors and identify a new security service;
an installation mechanism adapted to connect to an adapter server, receive a security adapter corresponding to said new security service, and install said security adapter in said extensible management console such that said extensible management console may be adapted to interact with said new security service; and
a user interface adapted to display a status of said new security service and receive input to be transmitted to said new security service.

19. The extensible management console of claim 18 further comprising:
a communications interface adapted to receive user input and, using said security adapter to generate a command for said new security service and transmit said command to said new security service.

20. A computer readable medium comprising computer executable instructions adapted to perform the functions of said extensible management console of claim 18.
